(19) United States
(12) Patent Application Publication
(10) Pub. No.: US 2021/0237952 A1
(43) Pub. Date: Aug. 5, 2021

(54) MARINE BIODEGRADABLE PAPER PRODUCTS

(71) Applicant: Hing Hwang, City of Industry, CA (US)

(72) Inventor: Hing Hwang, City of Industry, CA (US)

(21) Appl. No.: 17/163,319

(22) Filed: Jan. 29, 2021

Related U.S. Application Data
(60) Provisional application No. 62/968,073, filed on Jan. 30, 2020.

(51) Int. Cl. B65D 65/46; B65D 3/06; A47G 19/03; A47G 21/02; A47G 21/18; A47G 23/02

(52) U.S. Cl. CPC B65D 65/466; B65D 3/06; A47G 23/0216; A47G 21/02; A47G 21/18; A47G 19/03

(57) ABSTRACT

Marine biodegradable paper products comprising siding attached to a base, the siding and the base comprising a marine biodegradable material, the marine biodegradable material comprising a combination of pulps configured to dissolve safely in water for marine life after a time period. Methods for disposing a paper product comprising utilizing the paper product to contain a liquid, disposing the paper product in water after consuming the liquid, and dissolving the paper product in the water.

### CROSS REFERENCE TO RELATED APPLICATION

This application claims the benefit of U.S. Provisional Patent Application No. 62/968,073, titled MARINE BIODEGRADABLE PAPER PRODUCTS, filed on Jan. 30, 2020, which is hereby incorporated by reference in its entirety.

### TECHNICAL FIELD

The present disclosure generally relates to green technology and, more particularly, to marine biodegradable paper products.

### BACKGROUND

The ocean covers over 70% of the Earth's surface and is essential to the well-being of the planet. Unfortunately, marine pollution is a growing problem in today's world. If left unchecked, marine pollution may lead to dire consequences for the planet.

### SUMMARY

Aspects of the present disclosure relate to marine biodegradable paper products comprising siding attached to a base, the siding and the base comprising a marine biodegradable material, the marine biodegradable material comprising a combination of pulps configured to dissolve safely in water for marine life after a time period.

Aspects of the present disclosure relate to methods for disposing a paper product comprising utilizing the paper product to contain a liquid, disposing the paper product in water after consuming the liquid, and dissolving the paper product in the water.

Aspects of the present disclosure relate to marine biodegradable cups comprising siding attached to a base, the siding and the base comprising a marine biodegradable material, the marine biodegradable material comprising a combination of pulps configured to dissolve safely in water for marine life after a time period.

The features and advantages described in the specification are not all inclusive and in particular, many additional features and advantages will be apparent to one of ordinary skill in the art in view of the drawings, specification, and claims.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an exemplary marine biodegradable cup, according to certain aspects of the present disclosure.

FIG. 2 illustrates a dissolving process for a marine biodegradable cup, according to certain aspects of the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the appended claims. Various aspects of the subject technology will now be disclosed according to particular but non-limiting examples. Various embodiments described in the present disclosure may be carried out in different ways and variations, and in accordance with a desired application or implementation.

In the following detailed description, numerous specific details are set forth to provide a full understanding of the present disclosure. It will be apparent, however, to one ordinarily skilled in the art, that embodiments of the present disclosure may be practiced without some of the specific details. In other instances, well-known structures and techniques have not been shown in detail so as not to obscure the disclosure.

Aspects of the present disclosure provide for marine biodegradable paper products, including marine biodegradable cups, bowls, utensils, plates, food containers, straws, cup sleeves, etc.

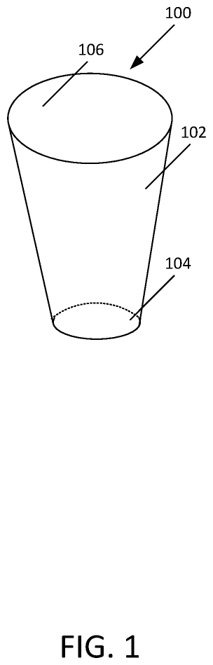

FIG. 1 illustrates an exemplary marine biodegradable cup 100, according to certain aspects of the present disclosure. For example, the cup 100 may be cylindrical in shape, and may include siding 102 attached to a base 104. The base 104 may be circular in shape. It is understood that the shape of the cup 100 is exemplary, and other shapes and dimensions are also allowed. For example, the base 104 may be polygonal in shape, and the siding 102 may be of various sizes and shapes as well. In an implementation, the cup 100 may be able to hold 16 oz. in volume. It is further understood that, although a cup is illustrated, other paper products, including bowls, utensils, plates, food containers, straws, and/or cup sleeves, etc., may also be included without departing from the scope of the disclosure.

According to aspects, the cup 100 may be formed from a marine biodegradable material, such as marine biodegradable paper. For example, the marine biodegradable material may be configured such that it dissolves in water over time and is safe for marine life. For example, the marine biodegradable material may become food for the marine life when dissolved.

According to aspects, the marine biodegradable material may include a combination of chemi-thermomechanical (CTMP) pulp and elemental chlorine free (ECF) chemical pulp. A ratio of the CTMP pulp to the ECF pulp may be modified according to various specifications (e.g., desired usage lifetime, desired dissolving time, etc.).

According to aspects, the marine biodegradable material may include 100% virgin forest fibers. For example, the virgin forest fibers may include a combination of Pine (Pinus Silvestris), Spruce (Picea Abies), and/or Birch (Betula spp.). Virgin fibers are advantageous over recycled fibers because recycled fibers may include non-intentionally added substances (NIAS) and traces of printing inks or mineral oils, which are undesirable. It is understood that other virgin fibers may be used in addition to the virgin fibers described herein. In an implementation, a ratio of the virgin forest fibers may be adjusted according to various specifications (e.g., desired usage lifetime, desired dissolving time, etc.). For example, the ratio may be 33% a first fiber (e.g., pine), 33% a second fiber (e.g., spruce), and 34% a third fiber (e.g, birch). It is understood that this ratio is exemplary only, and other ratios including one or more fibers may be used. For example, one fiber, two fibers, three fibers, or more may be used.

According to aspects, the marine biodegradable material does not exceed migration limits for at least the following stimulants: 3% acetic acid, 20% ethanol, and 50% ethanol. For example, the migrations limits for each stimulant may be less than 10 mg/dm², when contact lasts for 30 minutes at 90 degrees Celsius. According to aspects, the surface to stimulant volume ratio (dm²/mL) may be 2.3/197 for 3% acetic acid, 2.3/98 for 20% ethanol, and 2.3/95 for 50% ethanol. It is understood that these stimulants and values are exemplary only and other stimulants and values may be included without departing from the scope of the disclosure.

According to aspects, the marine biodegradable material may be gluten free (e.g., gluten content, if any, does not exceed 20 mg/kg). According to aspects, no additive of animal origin is included in the marine biodegradable material. According to aspects, the marine biodegradable material is safe to use with food and/or drink for human consumption. According to additional aspects, the marine biodegradable material may not deteriorate organoleptic characteristics of food and/or drink that comes into contact with the marine biodegradable material.

According to aspects, the cup 100 may be optimized such that it is able to hold liquids for at least a certain lifespan (e.g., at least two hours). It is understood that the cup 100 may be configured for other lifespans longer or shorter than two hours. For example, the cup 100 may be able to hold a liquid for at least two hours before the structure of the cup begins to degrade. This is because the cup 100 is configured to dissolve in water. The cup 100 also does not include any coatings that would interfere with its marine biodegradable properties.

According to aspects, the cup 100 may be configured to dissolve in water after a certain period (e.g., two hours). It is understood that the cup 100 may be configured to dissolve after other periods of time longer or shorter than two hours.

According to aspects, the cup 100 may be coated with a water-based coating to increase its lifespan. For example, the water-based coating may be applied to an inside surface 106 of the cup 100. The inside surface 106 may include an inside surface of the base 104. The water-based coating is environmentally friendly and water soluble, such that it is also marine biodegradable. The water-based coating is an improvement over conventional polyethylene (PE) coatings because the water-based coating is environmentally friendly and marine biodegradable, whereas PE is not.

Conventional methods teach against utilizing water soluble paper products for holding liquids because the liquids would dissolve the paper products. Advantages of utilizing a water soluble paper product (e.g., the marine biodegradable material) includes its ability to dissolve in water. As described above, the marine biodegradable paper product may be optimized to be able to hold a liquid for a certain lifespan before losing its structural integrity. By taking advantage of the marine biodegradable properties, the paper product is able to perform what may have been considered impossible before—it can both hold water and safely dissolve in water.

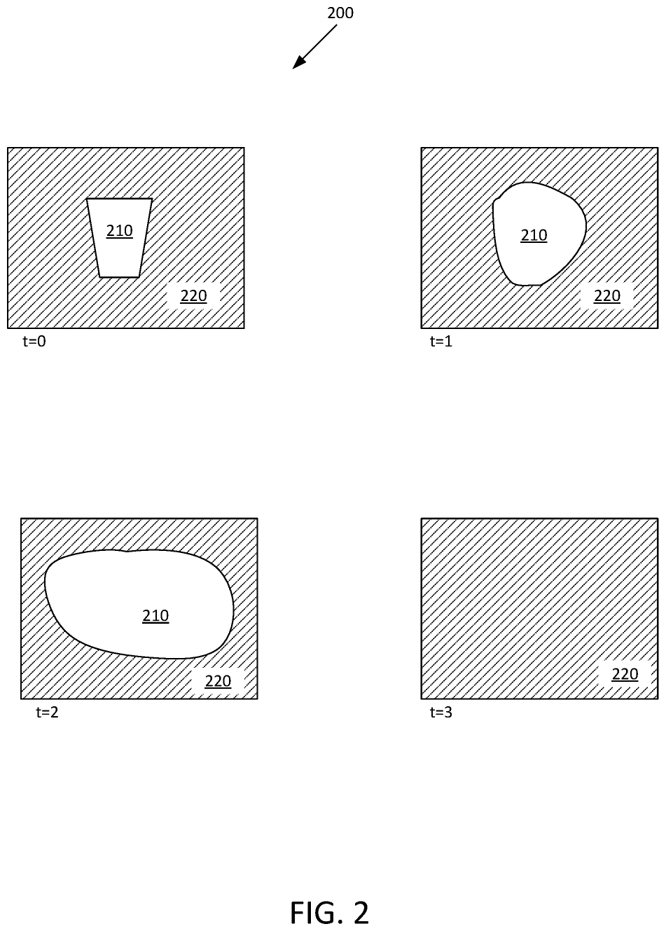

FIG. 2 illustrates a dissolving process 200 for a marine biodegradable cup 210, according to certain aspects of the present disclosure. As shown, at time t=0, the cup 210 is introduced to water 220 (e.g., ocean water, salt water, liquid, solvent, H₂O, etc.). At time t=1, the cup 210 begins to dissolve. For example, time t=1 may be after a certain period (e.g., two hours). According to aspects, the cup 210 may still appear to be intact to a user. At time t=2, the cup 210 is over halfway dissolved. For example, time t=2 may be only a few minutes after t=1. Alternatively, time t=2 may be a few seconds, minutes, or hours after time t=1, depending on how quickly the cup 210 is configured to dissolve. At time t=3, the cup 210 is completely dissolved. For example, time t=3 may be defined as the dissolving time. The dissolving time may be the total time it takes for the cup 210 to dissolve completely, leaving only pulp that is safe for marine life. The total time may be adjusted based on how quickly the cup 210 is configured to dissolve, as described above.

The process 200 may include utilization of the cup 210 prior to time t=0. For example, at time t=−1, the cup 210 may have been used to contain coffee for a time period. The time t=−1 may be up to two hours, or any other period, depending on the configured lifespan of the cup 210. Because the cup 210 has already been used for coffee, it would take a shorter period of time to dissolve than had the cup 210 not been used.

According to an aspect, the process 200 may include a user using the cup 210 for a beverage. The user finishes the beverage. The user then dispenses the cup 210 into water. The cup 210 then dissolves completely into pulp that is safe for marine life.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The word “exemplary” is used herein to mean “serving as an example or illustration.” Any aspect or design described herein as “exemplary” is not necessarily to be construed as preferred or advantageous over other aspects or designs. In one aspect, various alternative configurations and operations described herein may be considered to be at least equivalent.

As used herein, the phrase “at least one of” preceding a series of items, with the term “or” to separate any of the items, modifies the list as a whole, rather than each item of the list. The phrase “at least one of” does not require selection of at least one item; rather, the phrase allows a meaning that includes at least one of any one of the items, and/or at least one of any combination of the items, and/or at least one of each of the items. By way of example, the phrase “at least one of A, B, or C” may refer to: only A, only B, or only C; or any combination of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain.

It is understood that some or all steps, operations, or processes may be performed automatically, without the intervention of a user. Method claims may be provided to present elements of the various steps, operations, or processes in a sample order, and are not meant to be limited to the specific order or hierarchy presented.

All structural and functional equivalents to the elements of the various aspects described throughout this disclosure that are known or later come to be known to those of ordinary skill in the art are expressly incorporated herein by reference and are intended to be encompassed by the appended claims. Moreover, nothing disclosed herein is intended to be dedicated to the public regardless of whether such disclosure is explicitly recited in the claims. No claims element is to be construed under the provisions of 35 U.S.C. § 112 (f) unless the element is expressly recited using the phrase “means for” or, in the case of a method, the element is recited using the phrase “step for.” Furthermore, to the extent that the term “include,” “have,” or the like is used, such term is intended to be inclusive in a manner similar to the term “comprise” as “comprise” is interpreted when employed as a transitional word in a claim.

The Title, Background, Brief Description of the Drawings, and Claims of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples and the various features are grouped together in various embodiments for the purpose of streamlining the disclosure. This method of disclosure is not to be interpreted as reflecting an intention that the claimed subject matter requires more features than are expressly recited in any claim. Rather, as the following claims reflect, inventive subject matter lies in less than all features of a single disclosed configuration or operation. The following claims are hereby incorporated into the Detailed Description, with each claim standing on its own to represent separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

What is claimed is:

1. A marine biodegradable paper product, comprising:
siding attached to a base, the siding and the base comprising a marine biodegradable material, the marine biodegradable material comprising a combination of pulps configured to dissolve safely in water for marine life after a time period.

2. The marine biodegradable paper product of claim 1, wherein the marine biodegradable paper product comprises at least one of cups, bowls, utensils, plates, food containers, straws, and/or cup sleeves.

3. The marine biodegradable paper product of claim 1, wherein the marine biodegradable material comprises virgin forest fibers.

4. The marine biodegradable paper product of claim 3, wherein the virgin forest fibers comprise at least one of Pine (Pinus Silvestris), Spruce (Picea Abies), and/or Birch (Betula spp.).

5. The marine biodegradable paper product of claim 3, wherein a ratio of the virgin forest fibers comprises at least 33% a first fiber, 33% a second fiber, and 33% a third fiber.

6. The marine biodegradable paper product of claim 5, wherein the ratio is adjustable according to at least one of a desired usage lifetime and/or a desired dissolving time.

7. The marine biodegradable paper product of claim 1, wherein the combination of pulps comprises marine biodegradable material comprises chemi-thermomechanical (CTMP) pulp.

8. The marine biodegradable paper product of claim 1, wherein the combination of pulps comprises marine biodegradable material comprises elemental chlorine free (ECF) chemical pulp.

9. The marine biodegradable paper product of claim 1, wherein the combination of pulps comprises chemi-thermomechanical (CTMP) pulp and elemental chlorine free (ECF) chemical pulp.

10. The marine biodegradable paper product of claim 1, wherein a ratio of the combination of pulps is adjustable according to at least one of a desired usage lifetime and/or a desired dissolving time.

11. A method for disposing a paper product, comprising:
utilizing the paper product to contain a liquid;
disposing the paper product in water after consuming the liquid; and
dissolving the paper product in the water.

12. The method of claim 11, wherein the liquid comprises a beverage.

13. The method of claim 11, wherein the paper product comprises at least one of cups, bowls, utensils, plates, food containers, straws, and/or cup sleeves.

14. The method of claim 11, wherein the water comprises ocean water.

15. The method of claim 11, further comprising:
introducing the paper product to the water at a first time; and
dissolving the paper product for a time period.

16. The method of claim 15, wherein the time period comprises two hours.

17. The method of claim 11, wherein the paper product is still intact after an initial time period.

18. The method of claim 17, wherein the paper product is over halfway dissolved after the initial time period.

19. The method of claim 18, wherein the paper product is completely dissolved within a few seconds, minutes, or hours after the initial time period.

20. A marine biodegradable cup, comprising:
siding attached to a base, the siding and the base comprising a marine biodegradable material, the marine biodegradable material comprising a combination of pulps configured to dissolve safely in water for marine life after a time period.
